(19) United States
(12) Patent Application Publication
(10) Pub. No.: US 2004/0028166 A1
(43) Pub. Date: Feb. 12, 2004

(54) Gas catalysis of fusion reactions

(76) Inventor: James Robert DeLuze, Honolulu, HI (US)

Correspondence Address: James Robert DeLuze, 2032 Kapiolani Blvd. Apt 1 C, Honolulu, HI, 96826, US

(21) Appl. No.: 10/360,923

(22) Filed: Feb. 6, 2003

Related U.S. Application Data
(60) Provisional application No. 60/355,086, filed on Feb. 7, 2002.

(51) Int. Cl. G21J 1/00

(52) U.S. Cl. 376/100

(57) ABSTRACT

An apparatus consisting of essentially tanks, valves, solenoid injector valves, regulators, and other mechanical, electrical, and electronic components, and computer software arranged in such a manner to store catalyst substances and to deliver these substances in predetermined amounts and pressures to a fusion reactor. The catalyst substances include methane, CH₄, hydrocarbons, carbonaceous substances, and other chemicals with the required qualities of catalyzing fusion reactions. These qualities include facilitating, accelerating and increasing the efficiency of fusion reactions. Additionally, this also includes the ability to decrease the intensity of the driving potentials required for proper operation of fusion reactions. These chemicals also must be able to exist in a gaseous or plasma state under the operational conditions of fusion reactors.

### CROSS-REFERENCE TO RELATED APPLICATIONS

“This application claims the benefit of Provisional Patent Application Serial No. 60/355,086, filed Feb. 7, 2002 by the present inventor.”

### FEDERALLY SPONSORED RESEARCH

Not applicable.

### SEQUENCE LISTING OR PROGRAM

Not applicable.

### BACKGROUND—FIELD OF INVENTION

This invention relates to hot nuclear fusion reactions of heavy and light hydrogen, and other fusion-reactive gases, for the production and recovery of energy.

### BACKGROUND—DESCRIPTION OF PRIOR ART

A reliable source of power supplies a basic need of modern society. To this end, inventors created several types of nuclear reactors. U.S. patent application Ser. No. 10/214,372 to DeLuze (2002) describe the “DeLuze Fusion Reactor”. The “DeLuze Fusion Reactor” utilizes the phenomenon of electrostatic particle acceleration of ionized gases as its principle mode of operation as a controlled nuclear-fusion reactor. It also utilizes the electrical and or mechanical injection and removal of respective fuel and spent gases. These reactors have no provision for the introduction of catalyzing gases into the fusion reaction.

### SUMMARY

The present invention comprises a catalyst gas injection apparatus to introduce catalyzing gases into the fusion reactor. The presence of controlled amounts of these gases will accelerate and increase the efficiency of the catalyzed fusion reactions. Also, the intensity of the driving potentials for proper operation of these fusion reactors will be reduced.

### OBJECTS AND ADVANTAGES

Accordingly, besides the objects and advantages of the catalyst gas injection apparatus described in my above patent, several objects and advantages of the present invention are:

(a) to provide for the controlled introduction of catalyzing gases into a fusion reactor.

(b) to accelerate and increase the efficiency of fusion reactions.

(c) to decrease the intensity of the driving potentials required for proper operation of fusion reactors.

(d) to provide for the introduction of catalyzing gases into a fusion reactor with a predetermined ratio of the catalyzing gases in relation to the fusion-reactive gases.

Further objects and advantages are to provide the introduction of catalyzing gases into the reactor in a manner consistent with the power level at which the reactor is operating. To allow for the introduction of these catalyzing gases to be controlled within a feedback loop coordinated with the other operating parameters of the reactor. Still further objects and advantages will become apparent from a consideration of the ensuing description and drawings.

### DRAWING FIGURES

FIG. 1 is a plumbing diagram for the reactor and it's associated fuel induction and waste gas removal systems as described in my above captioned provisional patent application in FIGS. 25 and 25A.

FIG. 2 is a plumbing diagram of only the catalyzing gas introduction system.

FIG. 3 is a plumbing diagram for the reactor, it's associated fuel induction and waste systems, and the catalyzing gas introduction system.

### REFERENCE NUMERALS IN DRAWINGS

13 wire conductor

23 conductive spherical reactor vessel

60 valve

63 pressure reduction regulator

66 light or heavy hydrogen source tank

71 coupling

72 check valve

73 surge tank

74 solenoid injector valve

75 pipe

76 baffled surge tank

77 turbine vacuum pump

79 piston vacuum pump

80 piston high pressure pump

81 exhaust tank

92 high vacuum surge tank

93 exhaust solenoid injector valve

94 catalyst gas solenoid injector valve

95 catalyst gas source tank

145 amplifier

146 digital to analog converter

147 analog to digital converter

149 vacuum sensor

150 motor controllers

154 digital bus

199 pressure sensor

200 computer system

238 heat absorbent bath

241 insulating and cooling bath

### DESCRIPTION OF INVENTION

Intake and Exhaust Systems

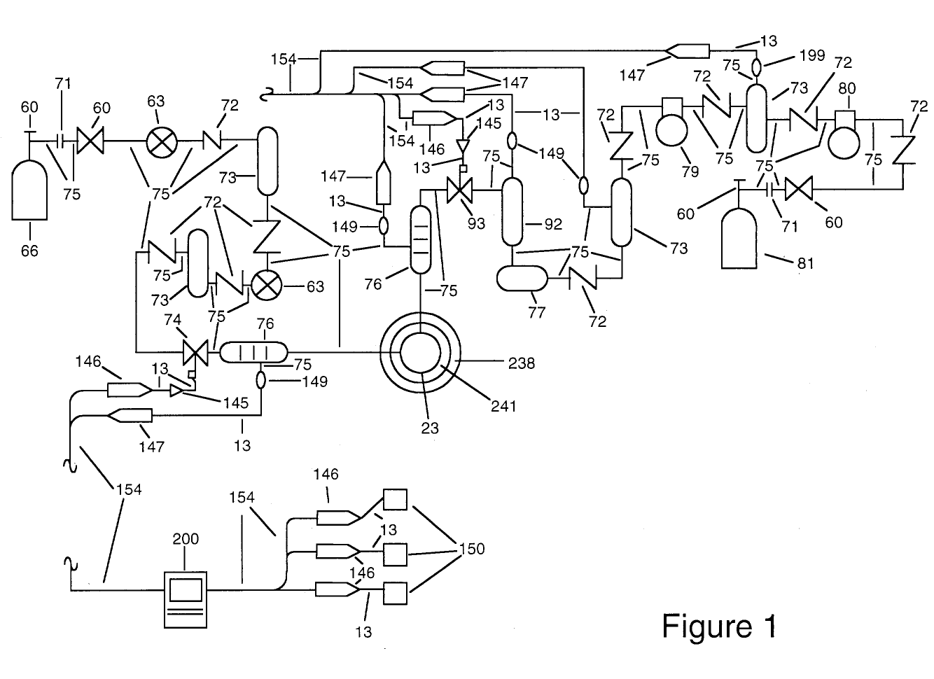

A plumbing diagram for the fuel and exhaust portions of the DeLuze Fusion Reactor is shown in FIG. 1. This drawing is a composite of FIGS. 25 and 25A in the above captioned provisional patent application. It consists of the fuel injection portion of FIG. 25 and the exhaust portion of FIG. 25A. The materials used, except where specified, conform to current standard power plant and plumbing practice.

Fuel Injection System

Light or heavy hydrogen source tank 66 controlled by valve 60 is connected by disconnect coupling 71 to valve 60. Valve 60 is then connected to pressure reduction regulator 63, by pipes 75. Pressure reduction regulator 63 is connected by check valve 72 through pipe 75 to surge tank 73. Surge tank 73 is connected by check valve 72 through pipe 75 to a second pressure reduction regulator 63. This second pressure reduction regulator 63 connects through check valve 72 via pipes 75 to a second surge tank 73.

This second surge tank 73 is connected by check valve 72 via pipes 75 to solenoid injector valve 74. Solenoid injector valve 74 is connected to baffled surge tank 76 by pipe 75. Baffled surge tank 76 is connected by pipe 75 to conductive spherical reactor vessel 23. Baffled surge tank 76 is also connected by another pipe 75 to vacuum sensor 149.

Vacuum sensor 149 is connected via wire conductor 13 to analog to digital converter 147. Analog to digital converter 147 is connected to digital bus 154. Digital bus 154 is connected to computer system 200. Computer system 200 connects via digital bus 154 to digital to analog converter 146. Digital to analog converter 146 connects via wire conductor 13 to amplifier 145. Amplifier 145 is connected via wire conductor 13 to solenoid injector valve 74.

Exhaust System

A conductive spherical reactor vessel 23 is contained by insulating and cooling bath 241 which in turn is contained by heat absorbent bath 238. This conductive spherical reactor vessel 23 is connected by pipe 75 to baffled surge tank 76. Baffled surge tank 76 is also connected to vacuum sensor 149. Vacuum sensor 149 is connected via analog to digital converter 147 to digital bus 154. Baffled surge tank 76 is also connected by pipe 75 to exhaust solenoid injector valve 93. Exhaust solenoid injector valve 93 is connected by pipe 75 to high vacuum surge tank 92.

High vacuum surge tank 92 is connected by pipe 75 to turbine vacuum pump 77. Turbine vacuum pump 77 is connected by check valve 72 to surge tank 73. High vacuum surge tank 92 and surge tank 73 are connected vacuum sensors 149. These two vacuum sensors 149 are connected via two analog to digital converters 147 to digital bus 154. Digital bus 154 is connected to computer system 200. Computer system 200 connects via digital bus 154 to digital to analog converter 146. Digital to analog converter 146 connects via wire conductor 13 to amplifier 145. Amplifier 145 connects via wire conductor 13 to exhaust solenoid injector valve 93. Computer system 200 also connects via digital bus 154 to a second digital to analog converter 146. This second digital to analog converter 146 is connected to motor controller 150. Motor controller 150 operates turbine vacuum pump 77.

Surge tank 73 is connected by check valve 72, and pipes 75 to piston vacuum pump 79. Piston vacuum pump 79 is connected by check valve 72, and pipes 75 to a second surge tank 73. Vacuum sensor 149 is connected by pipe 75 to second surge tank 73.

Vacuum sensor 149 is connected by wire 13 to analog to digital converter 147 and to digital bus 154. Digital bus 154 is connected to computer system 200. Computer system 200 connects via digital bus 154 to digital to analog converter 146. Digital to analog converter 146 connects via wire conductor 13 to another motor controller 150. Motor controller 150 operates piston vacuum pump 79.

This second surge tank 73 is connected by check valve 72, and pipes 75 to piston high pressure pump 80. Piston high pressure pump 80 is connected by check valve 72, and pipes 75 to valve 60. Valve 60 is connected via pipe 75 to disconnect coupling 71. Disconnect coupling 71 is connected via pipe 75 to a second valve 60. This second valve 60 controls and connects to exhaust tank 81.

This second surge tank 73 is connected to pressure sensor 199. Pressure sensor 199 is connected via wire conductor 13 to analog to digital converter 147. Analog to digital converter 147 is connected to digital bus 154. Digital bus 154 is connected to computer system 200. Computer system 200 connects via digital bus 154 to digital to analog converter 146. Digital to analog converter 146 connects via wire conductor 13 to another motor controller 150. Motor controller 150 operates piston high pressure pump 80.

Catalyst Gas Injection System

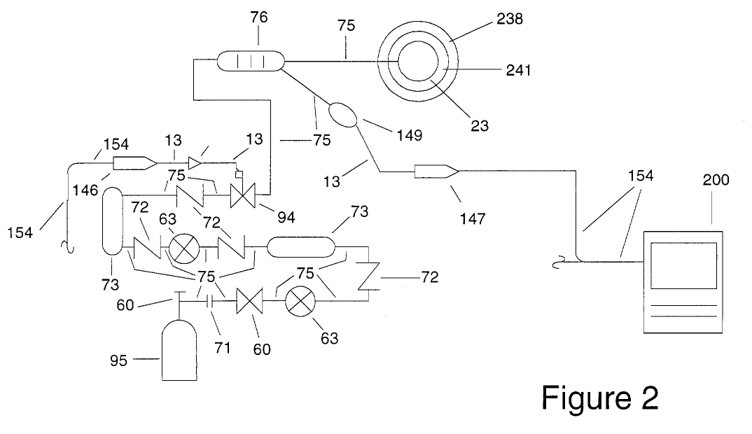

A plumbing diagram for the catalyst gas injection system for fusion reactors is shown in FIG. 2. Catalyst gas source tank 95 controlled by valve 60 is connected by disconnect coupling 71 to valve 60 by pipes 75. Valve 60 is then connected to pressure reduction regulator 63 by pipe 75. Pressure reduction regulator 63 is connected by check valve 72 through pipe 75 to surge tank 73. Surge tank 73 is connected by pipes 75 through check valve 72 to a second pressure reduction regulator 63. This second pressure reduction regulator 63 is connected through check valve 72 to a second surge tank 73.

This second surge tank 73 is connected by pipes 75 through check valve 72 to catalyst gas solenoid injection valve 94. Catalyst gas solenoid injection valve 94 is connected to baffled surge tank 76 by pipes 75. Baffled surge tank 76 is connected by pipe 75 to conductive spherical reactor vessel 23. Baffled surge tank 76 is also connected by another pipe 75 to vacuum sensor 149.

Vacuum sensor 149 is connected via wire conductor 13 to analog to digital converter 147. Analog to digital converter 147 is connected to digital bus 154. Digital bus 154 is connected to computer system 200. Computer system 200 connects via digital bus 154 to digital to analog converter 146. Digital to analog converter 146 connects via wire conductor 13 to amplifier 145. Amplifier 145 is connected via wire conductor 13 to catalyst gas solenoid injection valve 94.

Materials

The catalyst gas in the preferred embodiment is methane, CH₄ However, the catalyst gas can be any other chemical with the qualities of catalyzing fusion reactions. These qualities include facilitating, accelerating and increasing the efficiency of fusion reactions. Additionally, this also includes the ability to decrease the intensity of the driving potentials required for proper operation of fusion reactions. These chemicals also must be able to exist in a gaseous state under the operational conditions of fusion reactors. Other such chemicals include hydrocarbons, carbonaceous chemicals, and other chemicals with the required properties outlined above.

Conductive spherical reactor vessel 23 in the preferred embodiment is stainless steel. However, the conductive reactor vessel can be any other material that can contain high vacuum, conduct electrical charge, and have high temperature stability. Such materials include other metals, and alloys. Also included are non-conductive materials such as glass, ceramics, or fluropolymer resin which have an internal conductive material coating such as deposited metals or an internal conductive mesh attached to the inner reactor surface.

Insulating and cooling bath 241 in the preferred embodiment is high temperature insulating oil. However, insulating and cooling bath 241 can be any liquid or gas with non-conductivity, low radiation absorption, high radiation transmittance, high temperature stability, and appropriate thermal transfer capability.

Pipe 75 in the preferred embodiment is glass. However, the pipe can consist of any other material capable of containing high vacuum and pressure and having high temperature stability. Additionally, in the vicinity and at the connection to the conductive spherical reactor vessel 23, pipe 75 must be an insulator. If connected to a suitable coupling (not shown), the distal portions of the pipe need not be an insulator. Suitable materials include copper, stainless steel, ceramics, and fluropolymer resin. Pipe 75, in locations other than connected to the conductive spherical reactor vessel 23, in the preferred embodiment is stainless steel. However, the pipe can consist of any other material capable of containing high vacuum and pressure and having high temperature stability.

The body of all valves and pumps in the preferred embodiment is stainless steel. However, the body of all valves and pumps can consist of any other material capable of containing high vacuum and pressure and having high temperature stability.

The electronic and electrical components conform to current standard electronic and electrical design practice.

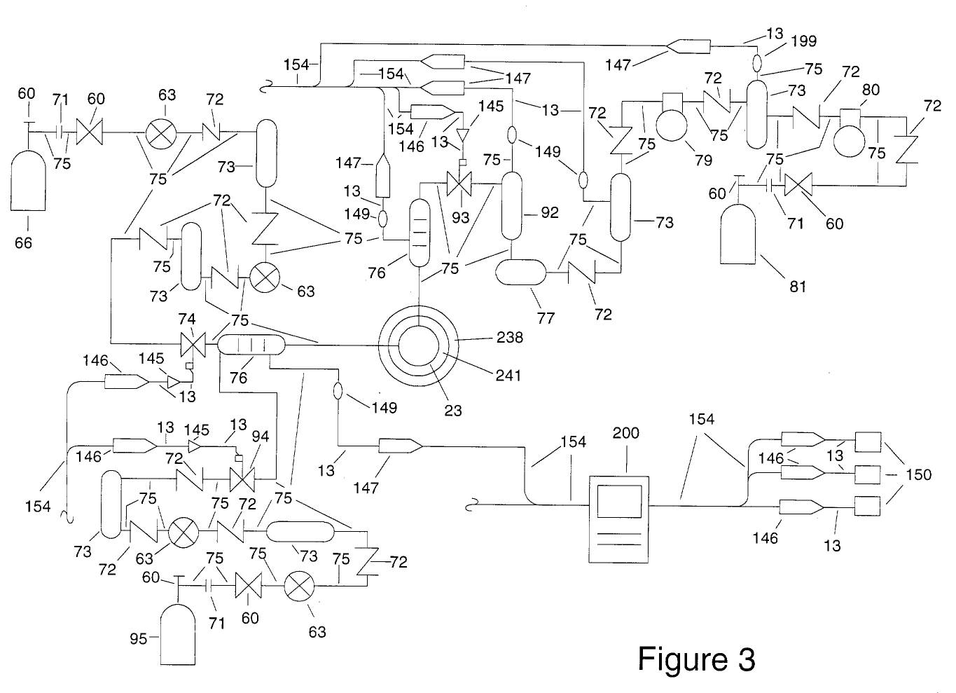

A plumbing diagram for the combined fuel, exhaust, and catalyst gas injection system for fusion reactors is shown in FIG. 3.

Operation of Invention

A plumbing diagram for the fuel and exhaust portions of the DeLuze Fusion Reactor is shown in FIG. 1. This drawing is a composite of FIGS. 25 and 25A in the above captioned patent application. It consists of the fuel injection portion of FIG. 25 and the exhaust portion of FIG. 25A. The reactor shown is a phase two spherical reactor, but the other reactor vessels may be substituted.

Fuel Injection System

Light or heavy hydrogen source tank 66 feeds hydrogen fuel through valves 60, pipes 75, check valves 72, to the first pressure reduction regulator 63. The fuel proceeds from the first pressure regulator 63 into the first surge tank 73. This results in a stable gas pressure of about 1 Torr in first surge tank 73. The gas proceeds through a second arrangement of check valves, pipes; and a second pressure regulator to the second surge tank 73. The hydrogen fuel gas pressure is now at about 0.01 Torr in second surge tank 73. The reason for the redundancy is to increase the gas pressure regulation stability, and to decrease pressure variations within the reactor chamber.

The gas now proceeds through one more check valve to solenoid injector valve 74. This valve feeds minute pulses of gas at a pressure of about 0.01 Torr into baffled surge tank 76. Baffled surge tank 76 has a volume many times greater than the volume of the reaction chamber. Additionally, this tank has internal baffles in order to prevent the pulsations of gas from the injector valve from directly short circuiting this tank. This combination minimizes gas pressure fluctuations in the reaction chamber.

The pressure of baffled surge tank 76 and conductive spherical reactor vessel 23 is regulated by a servo feedback system. This servo feedback system consists of vacuum sensor 149, analog to digital converter 147, computer system 200, digital bus 154, digital to analog converter 146, amplifier 145, and solenoid injector valve 74. This system utilizes vacuum sensor 149 to feed pressure data to computer system 200. Computer system 200 analyzes this data, and then sends control signals operating solenoid injector valve 74. This control system maintains a predetermined pressure within the reaction chamber.

Exhaust System

Reaction chamber 23 is connected via pipe 75 to baffled surge tank 76. Baffled surge tank 76 has a volume many times greater than that of the reaction chamber. The pressure of this exhaust baffled surge tank and conductive spherical reactor vessel 23 is controlled by a second servo feedback system working in coordination with the first one described above.

This servo feedback system consists of vacuum sensor 149, analog to digital converter 147, computer system 200, digital bus 154, digital to analog converter 146, amplifier 145, and exhaust solenoid injector valve 93. This system utilizes a second vacuum sensor 149 to feed pressure data to computer system 200. Computer system 200 analyzes this data, and then sends control signals operating exhaust solenoid injector valve 93. Computer system 200 coordinates the operation of these two servo feedback systems. This control system maintains a predetermined pressure within the reaction chamber.

Exhaust solenoid injector valve 93 is connected by pipe 75 to the high vacuum surge tank 92. The exhaust solenoid injector valve 93 discharges into high vacuum surge tank 92. High vacuum surge tank 92 has a volume many times that of second baffled surge tank 76. High vacuum surge tank 92 is at a higher vacuum, about 0.000001 Torr or greater. Exhaust solenoid injector valve 93 feeds minute pulses of gas at a pressure of about 0.01 Torr into high vacuum surge tank 92. This results in very incremental and precise control of the pressure within the reaction chamber. The pulsations of the exhaust and injector valves are coordinated by the computer system 200. This results in a coordinated control of reaction chamber pressure by the first and second servo feedback loops. This coordinated control by computer system 200 results in very fine regulation of the reactor vessel pressure. Pressure pulsations within the reaction chamber are minimized.

High vacuum surge tank 92 is connected to turbine vacuum pump 77. The pressure of high vacuum surge tank 92 is controlled by a third feedback loop. This third feedback loop consists of vacuum sensor 149, analog to digital converter 147, computer system 200, digital bus 154, digital to analog converter 146, motor controller 150, and turbine vacuum pump 77. This system utilizes vacuum sensor 149 to feed pressure data to computer system 200. Computer system 200 analyzes this data, and then sends control signals operating motor controller 150. Motor controller 150 controls the operation of turbine vacuum pump 77. This controlled operation of turbine vacuum pump 77 maintains the pressure within high vacuum surge tank 92 within predetermined amounts.

Turbine vacuum pump 77 pumps the gas through another check valve into surge tank 73, whose pressure is monitored by vacuum sensor 149 feeding data back to the computer system 200 via analog to digital converter 147 connected to digital bus 154. Computer system 200 then sends control signals to another digital to analog converter 146, which operates the motor controller 150 controlling the operation of piston vacuum pump 79. This system is a servo feedback loop regulating the pressure of the second surge tank 73.

Second surge tank 73 is connected to piston high pressure pump 80 by a check valve. Piston high pressure pump 80 discharges gas via a check valve, valve 60, coupling 71, and valve 60 into exhaust tank 80. As a result the spent and residual gases from the reaction chamber are collected into and contained within this exhaust tank 80.

The pressure of second surge tank 73 is at or above atmospheric pressure and is regulated by a fourth servo mechanism. This fourth servo mechanism consisting of pressure sensor 199 feeding data back to the computer system 200 via analog to digital converter 147 connected to digital bus 154. Computer system 200 then sends control signals to another digital to analog converter 146 which operates the motor controller 150 controlling the operation of piston high pressure pump 80.

Catalyst Gas Injection System

Catalyst gas source tank 95 feeds catalyst gas through valves 60, coupling 71, pipes 75, check valves 72, to the first pressure reduction regulator 63. The catalyst gas proceeds from the first pressure regulator 63 into the first surge tank 73. This results in a stable gas pressure of about 1 Torr in first surge tank 73. The gas proceeds through a second arrangements of check valves, pipes, and a second pressure regulator to the second surge tank 73. The catalyst gas pressure is now at about 0.01 Torr in second surge tank 73. The reason for the redundancy is to increase the gas pressure regulation stability, and to decrease pressure variations within the reactor chamber.

The gas now proceeds through one more check valve to catalyst gas solenoid injector valve 94. This valve feeds minute pulses of catalyst gas at a pressure of about 0.01 Torr into baffled surge tank 76. Baffled surge tank 76 has a volume many times greater that the volume of the reaction chamber. Additionally, this tank has internal baffles in order to prevent the pulsations of gas from the injector valve from directly short circuiting this tank. This combination minimizes gas pressure fluctuations in the reaction chamber.

The pressure of baffled surge tank 76 and conductive spherical reactor vessel 23 is regulated by a servo feedback system. This first servo feedback system was described above in the section on the fuel injection system. The catalyst gas injection system is an integral part of this first servo feedback loop.

This servo feedback system consists of vacuum sensor 149, analog to digital converter 147, computer system 200, digital bus 154, two digital to analog converters 146, two amplifiers 145, solenoid injector valve 74, and catalyst gas solenoid injector valve 94. This system utilizes vacuum sensor 149 to feed pressure data to computer system 200. Computer system 200 analyzes this data, and then sends control signals operating solenoid injector valve 74, and catalyst gas solenoid injector valve 94. This control system maintains a predetermined pressure within the reaction chamber.

### Computer System

As described above, there are multiple servo feedback loops governing the operation of these systems. These are under the control of computer system 200. The first feedback loop involving solenoid injector valve 74, and catalyst gas solenoid injector valve 94, is most relevant to this gas catalyst injection system.

Based on the data from various sensors, operational load demands upon the reactor, and predetermined operational parameters, computer system 200 governs the operation of the fuel and catalyst gas injection systems. This includes the amounts of fuel and catalyst gases delivered, and the proportional ratio of these gases. Additionally, the proportional ratio of these gases may be changed for differing operating parameters of the reactor. The varying reaction parameters, and their interactions, will be part of the program of computer system 200. With this data, computer system 200 will be able to change the operating parameters of the reactor, and it's associated systems, in a predetermined manner. This will include the introduction of gases at predetermined amounts and ratios conducive to the most efficient, and effective operation of the reactions involved.

Conclusion, Ramifications, and Scope

Accordingly, the reader will see that the gas catalysis system of this invention can be used to introduce catalyzing gases into a fusion reactor, can accelerate and increase the efficiency of fusion reactions, and reduce the intensity of the driving potentials required for proper operation of fusion reactors. Furthermore, this gas catalysis system has the additional advantages in that it:

provides for the controlled introduction of catalyzing gases into a fusion reactor

provides for the introduction of catalyzing gases into a fusion reactor with a predetermined ratio of the catalyzing gases in relation to the fusion-reactive gases

provides for the introduction of catalyzing gases into the reactor in a manner consistent with the power level at which the reactor is operating

provides for the introduction of these catalyzing gases to be controlled within a feedback loop coordinated with the other operating parameters of the reactor

While my above description contains many specificities, these should not be construed as limitations on the scope of the invention, but rather as an exemplification of one preferred embodiment thereof. Accordingly, the scope of the invention should be determined not by the embodiment (s) illustrated, but by the appended claims and their legal equivalents.

I claim:

1. A substance with appropriate catalyst actions as a catalyst for fusion reactions.

2. The substance of claim 1 in which said substance is a carbonaceous compound as a catalyst for fusion reactions.

3. The substance of claim 1 in which said substance is a hydrocarbon as a catalyst for fusion reactions.

4. The substance of claim 1 in which said substance is Methane, CH₄, as a catalyst for fusion reactions.

5. A means of introducing a catalyzing substance into a fusion reactor.

6. The means of claim 5 in which said means is a means of introducing a catalyzing substance into a fusion reactor as a gas.

7. The means of claim 5 in which said means is a means of introducing a catalyzing substance into a fusion reactor in a controlled manner.

8. The means of claim 5 in which said means is a means of introducing a catalyzing substance into a fusion reactor with a predetermined ratio of the catalyzing gases in relation to the fusion-reactive gases.

9. The means of claim 5 in which said means is a means of introducing a catalyzing substance into a fusion reactor in a manner consistent with the power level at which the reactor is operating.

10. The means of claim 5 in which said means is a means of introducing a catalyzing substance into a fusion reactor in a manner to be controlled within a feedback loop coordinated with the other operating parameters of the reactor.

11. An apparatus for injecting, extracting, and accurately regulating the catalyst gas pressure within a fusion reactor to a predetermined level; for monitoring the operational parameters of the fusion reactor, temperature and radiation levels, and thereby using this data to determine the ratio of the catalyzing gases in relation to the fusion-reactive gases, and to control the introduction of these catalyzing gases in these predetermined amounts; this apparatus comprising:
(A) a catalyzing substance storage and regulation means whereby a catalyzing substance is delivered to the catalyst gas solenoid injector valve means at a predetermined pressure
(B) a catalyst gas solenoid injector valve means whereby catalyzing substance is injected in a controllable manner at a predetermined pressure and amount into the pulsation dampening means and then respectively into the spherical conductive reactor vessel means
(C) an exhaust valve means for the extraction of gases in controlled predetermined amounts, at predetermined pressures from the spherical conductive reactor vessel means through pulsation dampening means and into exhaust gas collection and storage means
(D) a pulsation dampening means whereby the gas pressure in the spherical conductive reactor vessel means is held at about a constant predetermined pressure regardless of the pulsations of the said exhaust valve means and or catalyst gas solenoid injector valve means
(E) an exhaust gas collection and storage means whereby extracted gases are collected, compressed and stored
(F) an electrical sensor means to monitor pressures within the fusion reactor vessel, and other system components
(G) a computer system means to monitor and control the operational parameters of the catalyst gas injection system.

12. The apparatus of claim 11 in which said electronic equipment means is essentially electrical and electronic components assembled in a manner to provide electrical control to all the valves, and motor controllers of said apparatus in a manner to control the injection, regulation, and extraction of said catalyst substances.

13. The apparatus of claim 11 in which said catalyst substance and regulation means is essentially tanks, valves, regulators and other mechanical, electrical and electronic components arranged in such a manner to store catalyst substances and to deliver these substances in predetermined amounts and pressures to the catalyst gas solenoid injector valve means.

14. The apparatus of claim 11 in which said catalyst gas solenoid injector valve means is an orifice which delivers predetermined amounts of catalyst gases at a predetermined pressure into the pulsation dampening means or directly into a fusion reactor.

15. The apparatus of claim 11 in which said catalyst gas solenoid injector valve means is an electrically controlled orifice which delivers predetermined amounts of catalyst gases at a predetermined pressure into the pulsation dampening means or directly into a fusion reactor.

16. The apparatus of claim 11 in which said catalyst gas solenoid injector valve means is a mechanically controlled orifice which delivers predetermined amounts of catalyst gases at a predetermined pressure into the pulsation dampening means or directly into a fusion reactor.

17. The apparatus of claim 11 in which said pulsation dampening means is an enclosed volume connected with said catalyst gas solenoid injector valve and said reaction chamber and an enclosed volume connected with said exhaust valve and said reaction chamber, configured in a manner to transfer said gases to and from said reaction chamber to said exhaust valve and from said injector valve in a manner to maintain pressure fluctuations within the said reaction chambers below a predetermined amount.

18. The apparatus of claim 11 in which said exhaust gas collection and storage means is essentially tanks, valves, regulators and other mechanical, electrical and electronic components arranged in such a manner to collect gases from said exhaust valve means and to compress and store said gases at a predetermined pressure.

19. The apparatus of claim 11 in which said computer system means includes software programing means to operate said electronic and computer means.
